(19) United States
(12) Patent Application Publication
(10) Pub. No.: US 2012/0139171 A1
(43) Pub. Date: Jun. 7, 2012

(54) Oxygen Lance with Coil

(75) Inventors: John Adrian Calvi, Bentleigh East (AU); Rodolfo Daniel Duran, Aspendale (AU)

(73) Assignee: Lewis Australia Pty Ltd., Victoria (AU)

(21) Appl. No.: 13/284,238

(22) Filed: Oct. 28, 2011

(30) Foreign Application Priority Data
Oct. 29, 2010 (AU) 2010904831

(51) Int. Cl. F27D 99/00

(52) U.S. Cl. 266/225

(57) ABSTRACT

An oxygen lance assembly that is at least capable of moving towards or away from the object to be lanced, said assembly including a supply of gaseous oxygen and metallic tubing wherein the oxygen supply is continuously feed through the said tubing when the lance is in use, and the said lance assembly includes a reel, and the said metallic tubing is coiled upon and carried by the said reel, and when in use, the metallic tubing is continuously uncoiled from the said reel as the said metallic tubing is consumed during use.

### CROSS REFERENCE TO RELATED APPLICATION

This application claims priority to Australian Patent Application 2010904831, filed Oct. 29, 2010. The above cited application is herein incorporated by reference as if fully set forth in its entirety.

### FIELD OF THE INVENTION

This invention relates to the field of oxygen lances, particularly to the type used to open tapping holes in furnaces.

### BACKGROUND OF THE INVENTION

Oxygen lances are regularly used for a number of different purposes, from cutting metal objects such as beams and other structural members through to opening tapping holes in furnaces and crucibles.

The basic oxygen lance is a simple device that includes a metallic tube of around 4 m in length, and an oxygen supply. A supply of oxygen gas is continuously fed through the tube. Once the oxygen lance is ignited, the supply of oxygen sustains the continuous burning of the metal tubing. The result is a lance with an extremely high heat that is capable of melting and burning through a wide range of suitable objects. The metal tubing is consumed when the lance is in use, and therefore the lance needs to be fitted with fresh tubes at regular intervals to replenish the tubes as they are consumed by the use of the lance. A thermic lance operates in a similar way but includes wires (usually steel) inserted within the metallic tube to provide additional fuel for more heat generation.

One particular application of a lance is the use on furnaces to open tapping holes. Furnaces used in metallurgy run at very high temperatures. The refractory materials used to line the interior of these furnaces are capable of operating at these elevated temperatures, however specialised cooling panels are sometimes integrated into the furnace wall to extend the life of the refractory by conducting some heat away. Typically a furnace is fitted with a plurality of tapping holes which are used to tap molten metal in the furnace. When not in use, these tapping holes are blocked with a refractory mud or clay. This plug is inserted using a clay or mud gun or manually with a bot (clay plug wrapped in refractory fabric pushed in with a steel rod). The plug sets very hard and has a high resistance to heat. The plug of refractory clay and solidified metal then remains in place until the next tapping operation falls due, upon which the plug then needs to be removed.

One common way of removing the plugs is by burning through them using an oxygen lance. The tip of the lance burns at around 4,000° C., and is capable of burning through the refractory clay or mud plug material and the solidified metal in the tap hole. It is common for a lance to need to be fitted with 10 to 20 fresh tubes in order to open just one tapping hole. This means that the operation needs to be halted 10 to 20 times while the lance is withdrawn from the hole and a fresh tube attached. Each time the lancing operation is halted, the tap hole cools to some degree. The environment where this operation needs to take place is inherently dangerous given the extreme heat of the furnace being operated on, the extreme heat of the oxygen lance itself, and the presence of oxygen around molten metals. The need to regularly stop the operation, withdraw the lance, fit it with a fresh tube and then re-insert the lance into the tapping hole adds considerable time to the tapping operation, as well as increases the exposure of the lance operators to risk.

It is an object of the present invention to overcome, or at least ameliorate the aforementioned problems.

### DISCLOSURE OF THE INVENTION

The present invention is an oxygen lance assembly that is at least capable of moving towards or away from the object to be lanced. The assembly includes a supply of gaseous oxygen and metallic tubing wherein the oxygen supply is continuously feed through the tubing when the lance is in use. The lance assembly includes a reel, and the metallic tubing is coiled upon and carried by the reel. When in use, the metallic tubing is continuously uncoiled from the reel as the metallic tubing is consumed during use of the lance.

Preferably the lance has a series of rollers that the metallic tubing passes through after it is uncoiled from the reel in order to straighten and guide the tubing.

Preferably at least one of the rollers in the series of rollers has adjustable means to adjust the straightening of the tubing.

Preferably the lance has a set of pinch rollers, and these rollers are capable of pulling on the tubing, and it is at least this pulling action that causes the metallic tubing to uncoil from the reel during use.

Preferably the rotation of the reel to uncoil the metallic tubing is powered by a motor, and the tubing is thereby forced through the series of straightening rollers by the powered uncoiling of the reel.

Preferably the tail end of the metallic tubing in one reel is connectable to the leading end of the metallic tubing in a subsequent reel so as to allow substantially continuous operation of the said lance as each reel of metallic tubing is consumed during use.

Preferably the tail end of the metallic tubing has a region of reduced diameter wherein the outer diameter of the said region is capable of being inserted into the inner diameter of the leading end of a new coil of metallic tubing such that when a reel of metallic tubing is consumed, the leading end of new reel of metallic tubing is slid over the region of reduced diameter so as to connect the ends of the metallic tubing together.

Preferably the reel is capable of accommodating a coil of metallic tubing that is at least 50 or 100 metres or more in linear uncoiled length, however in consideration of weight and handling requirements, the coils are typically in the range of 18 to 30 metres in linear uncoiled length.

Optionally the metallic tubing used in the lance includes additional fuel wires incorporated into the tube.

Preferably the lance is carried on a body that is suspended from a ceiling, and the body is movable in three dimensions.

Preferably the body contains strain gauges or similar features to provide feedback to the lance operators of the forward acting force being applied to the lance during operation.

Preferably the oxygen lance includes a shield to minimise the splash back of sparks and/or molten material erupting from the tap hole as it is being lanced. The shield is comprised of a planar sheet of suitable heat resistant material. The planar sheet includes a suitable notch or orifice that allows the metallic tubing of the lance to pass through the planar sheet.

Preferably the oxygen lance assembly includes a tap hole plugging tool. The tap hole plugging tool comprises of a shaft member that is removably fastenable to the oxygen lance assembly at one end, and the shaft extends in the direction of the metal tubing of the lance and has a plunger permanently attached at the opposite end of the shaft. The plunger being capable of holding a plug of suitable material for the tap hole, and the oxygen lance assembly with the plugging tool attached is then used to position and force the plug into position relative to the tap hole. In this arrangement the oxygen lance assembly is reconfigured to allow it to close a furnace tap hole.

### BRIEF DESCRIPTION OF THE DRAWINGS

FIG. 1 shows a side view of the oxygen lance in accordance with the present invention shown in the configuration where it is suspended from a ceiling.

FIG. 2 shows a rear end view of the lance.

FIG. 3 shows one form of connector that can be used to connect the tail end of one coil of metallic tubing the leading end of a subsequent coil of metallic tubing. This connector has barb rings or serrations that ensure that once the connection is pushed together, it cannot be pulled apart.

FIG. 4 shows an alternative connection using one swaged end inserted into the end of the previous coil and then crimped together as shown with a special hand tool to prevent separation and create effective gas sealing. Alternatively the joint can be glued together.

FIG. 5 shows a side view of the present invention with a tap hole plug plunger temporarily attached.

### INTEGER LIST

1 Oxygen lance assembly
3 Metallic tubing
5 Reel
7 Flame
9 Straightening and guide rollers
11 Pinch rollers
13 Coil of metallic tubing
15 Oxygen supply line
17 Oxygen valve
19 Oxygen supply hose
21 Index motor
22 Support member
23 Tube feed motor
25 Trailing end of preceding metallic tubing
27 Lead end of new metallic tubing
29 Connector
31 Join
33 Serrations
35 Region of reduced diameter
37 Guide rollers
39 Crimp
41 Shaft
43 Plunger
45 Attachment means
47 Tap hole plug
49 Furnace wall
51 Tap hole
53 Adjustable guide shield
55 Water cooled jacket

### DETAILED DESCRIPTION OF THE PREFERRED EMBODIMENTS

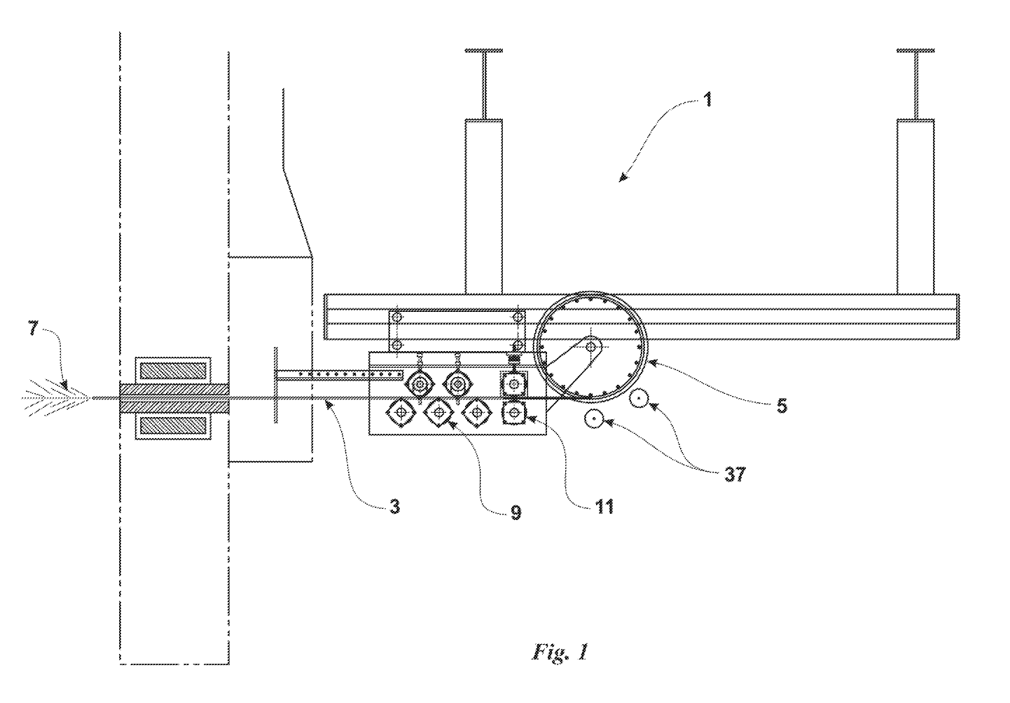

Turning firstly to FIG. 1, we see an oxygen lance 1 having a gaseous oxygen supply (not shown) and metallic tubing 3 that is carried on the lance in the form of a coil which is carried upon reel 5. When the lance is in use, the metallic tubing 3 is consumed by the flame 7, and new tubing is continuously fed from the coil. As the metallic tubing 3 is unwound from the coil it passes through a series of adjustable straightening and guide rollers 9. The coils of tubing are supplied in the form of a cartridge that can be very quickly placed onto the reel 5 when necessary, and have the oxygen supply re-attached.

The coil is either pulled from the coil using a pair of pinch rollers 11, or alternatively, the reel is coupled to an electric pneumatic or hydraulic motor which provides the torque required to turn the reel, or a combination of both the push of the motor and the pull of the pinch rollers 11 may be used in conjunction with one another. Optionally a set of guide rollers 37, or a guide rail (not shown) is attached to the reel to ensure that as the reel is turned by the electric motor, the metallic tubing is unable to simply unwind off the reel and not travel through the straightening rollers.

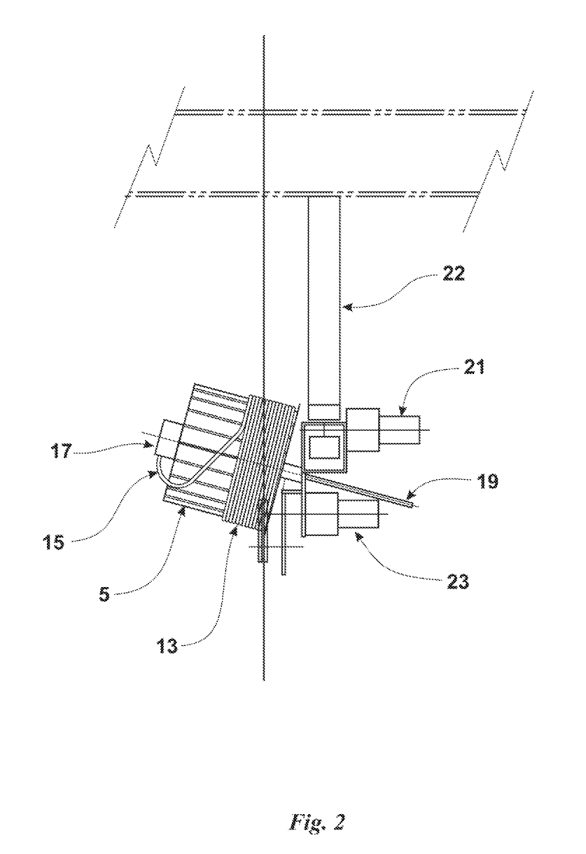

Turning to FIG. 2 we see a rear end view of the lance showing the coil of metallic tubing 13 coiled around the reel 5. An oxygen supply line 15 is attached to the trailing edge of the metallic coil. The opposite end of the oxygen supply line 15 is attached to a valve with a rotary joint 17. The oxygen is fed to the valve 17 via supply hose 19 which is attached to the oxygen supply remote from the lance assembly. In this embodiment, the lance assembly is wholly suspended from the ceiling via a support member 22. This is preferable due to the fact that the tapping floor of a furnace is typically a very busy area with sub-floor launders or above floor launders in place to channel the flow of molten metal from the furnace. In other environments, it is conceivable for the lance to be wholly supported by the floor and run on rails or the like to allow for the lance to be moved towards or away from the job to be worked on by the lance.

An index motor 21 may be provided to move the lance assembly closer to, or away from the job to be worked on. Another motor 23 may be included to feed the tube off the reel during the use of the lance. This motor may be used in conjunction with a set of pinch rollers 11.

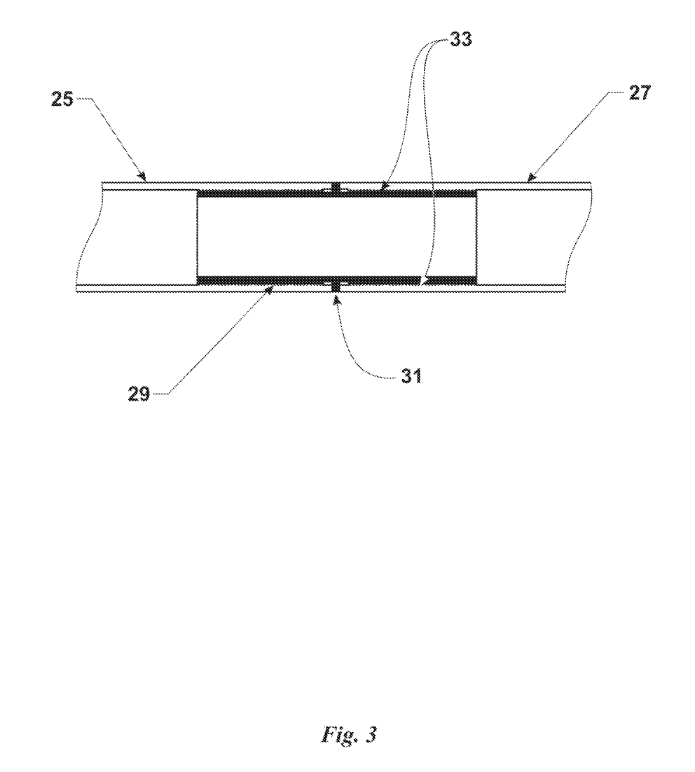

Before a cartridge of metallic tubing has been consumed, a new cartridge is placed upon the reel 5, and the trailing end of the preceding metallic tube is connected to the leading edge of the new cartridge of metallic tubing. FIG. 3 shows one preferred way in which the two ends are joined. The trailing end 25 of the metallic tubing from the preceding cartridge is butted against the leading end 27 of the metallic tubing in the new cartridge. The two ends meet at the join 31 and a connector member 29 is inserted into each end and makes an interference fit to hold the ends together. It is preferable that the connector 29 includes a set of serrations 33 to make the connector 29 easier to insert into the ends, and to improve the oxygen seal.

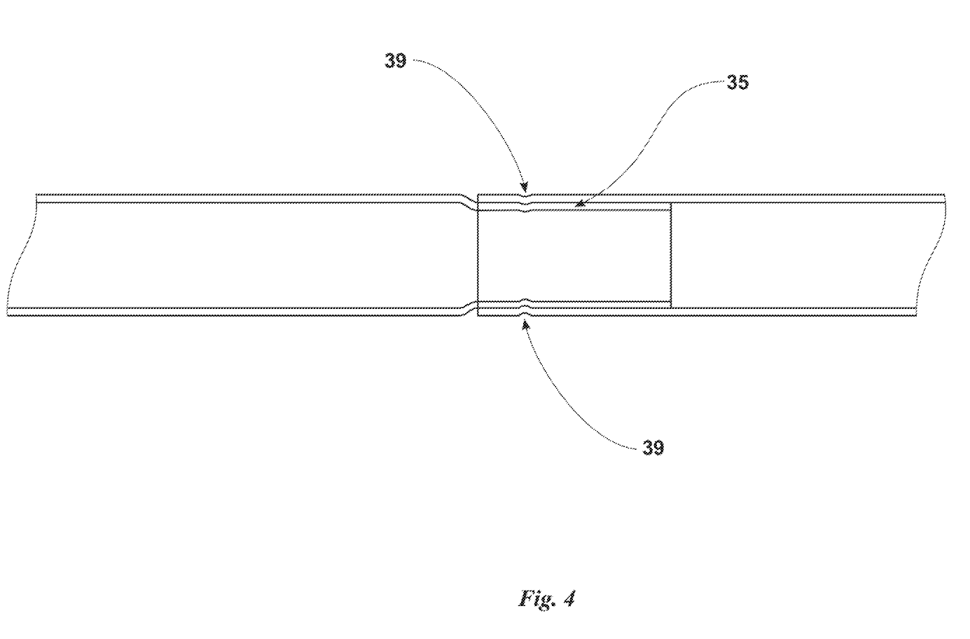

There is also an alternative method of joining the ends together. Instead of using a connector, either the lead end 27 of the metallic tubing from the new cartridge, or the trailing end 25 of the preceding metallic tubing may have a region that is of reduced diameter 35, as shown in FIG. 4. The outside diameter of 35 is sized so that it is insertable into an end of the metallic tubing. If the trailing end 25 of the preceding metallic tubing has the region 35, then it is insertable into the leading end 27. Conversely, if the leading end 27 has the region of reduced diameter 35, then it is insertable into the trailing end 25 of the preceding metallic tubing. Optionally the joined ends may be crimped as shown at 39 to increase the strength of the join.

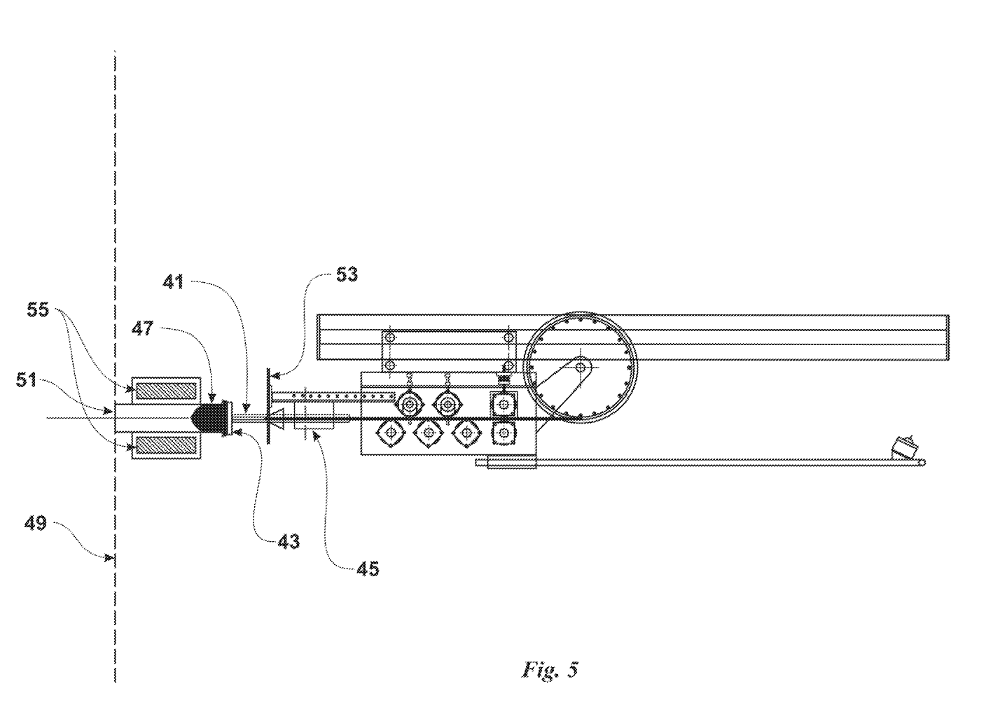

Turning to FIG. 5, we see that the present invention can be reconfigured to provide the means for plugging a tap hole that has been lanced open. A tap hole plug plunger comprising a shaft 41 and a plunger at its remote end 47 is removably fastenable to the body of the oxygen lance assembly via attachment means 45. In its simplest form, the fastening means is a clamp. The plunger 43 is capable of holding a plug of suitable refractory material(s), and the body of the oxygen lance assembly, can then be manipulated in three dimensions to enable the plug to be positioned and forced into the tap hole 51. When the operator(s) wishes to reconfigure the assembly from a lance to a tap hole plunger, they can simply trim any excess metal tubing that may be extending from the lance, and simply attach the tap hole plug plunger with a pre-prepared plug attached.

Whilst the above description includes the preferred embodiments of the invention, it is to be understood that many variations, alterations, modifications and/or additions may be introduced into the constructions and arrangements of parts previously described without departing from the essential features or the spirit or ambit of the invention.

It will be also understood that where the word “comprise”, and variations such as “comprises” and “comprising”, are used in this specification, unless the context requires otherwise such use is intended to imply the inclusion of a stated feature or features but is not to be taken as excluding the presence of other feature or features.

The reference to any prior art in this specification is not, and should not be taken as, an acknowledgment or any form of suggestion that such prior art forms part of the common general knowledge in Australia.

What is claimed is:

1. An oxygen lance assembly that is at least capable of moving towards or away from the object to be lanced, said assembly including a supply of gaseous oxygen and metallic tubing wherein the oxygen supply is continuously feed through the said tubing when the lance is in use, and the said lance assembly includes a reel, and the said metallic tubing is coiled upon and carried by the said reel, and when in use, the metallic tubing is continuously uncoiled from the said reel as the said metallic tubing is consumed during use.

2. The oxygen lance assembly as claimed in claim 1 wherein the said lance has a series of rollers that the metallic tubing passes through after it is uncoiled from the said reel in order to straighten and guide the said tubing.

3. The oxygen lance assembly as claimed in claim 2 wherein at least one of the rollers in the said series of rollers has adjustable means to adjust the straightening of the tubing.

4. The oxygen lance assembly as claimed in claim 3 wherein the said lance has a set of pinch rollers, and these rollers are capable of pulling on the tubing, and it is at least this pulling action that causes the metallic tubing to uncoil from the reel at the required rate to provide lancing in the tap hole.

5. The oxygen lance assembly as claimed in claim 3 wherein the rotation of the said reel to uncoil the said metallic tubing is powered by a motor, and the said tubing is thereby forced through the said series of straightening rollers by the powered uncoiling of the reel.

6. The oxygen lance assembly as claimed in claims 4 wherein the tail end of the metallic tubing in one reel is connectable to the leading end of the metallic tubing in a subsequent reel so as to allow substantially continuous operation of the said lance as each reel of metallic tubing is consumed during use.

7. The oxygen lance assembly as claimed in claim 6 wherein the connection of the tail end of the metallic tubing in one reel to the leading end of the metallic tubing in a subsequent reel is substantially gas tight.

8. The oxygen lance assembly as claimed in claim 7 wherein the tail end of the said metallic tubing has a region of reduced diameter wherein the outer diameter of the said region is capable of being inserted into the inner diameter of the leading end of a new coil of metallic tubing such that when a said reel of metallic tubing is consumed, the leading end of new reel of metallic tubing is slid over the said region of reduced diameter so as to connect the ends of the metallic tubing together.

9. The oxygen lance assembly as claimed in claim 8 wherein the said reel is capable of accommodating a coil of metallic tubing at least 50 or 100 metres or more in linear uncoiled length, however in consideration of weight and handling

10. The oxygen lance assembly as claimed in claim 9 wherein the said lance is carried on a body that is suspended from a ceiling, and the body is movable in three dimensions.

11. The oxygen lance assembly as claimed in claim 10 wherein the assembly contains force feedback information means that give the operator information relating to the forward thrust of the lance when in operation.

12. The oxygen lance assembly as claimed in claim 11 wherein the force feedback information means is a strain gauge.

13. The oxygen lance assembly as claimed in claim 12 wherein the oxygen lance includes a shield to minimise the splash back of sparks and/or molten material erupting from the tap hole, said shield comprising a planar sheet of suitable heat resistant material, said planar sheet includes a suitable notch or orifice that allows the metallic tubing of the lance to pass through the said planar sheet.

14. The oxygen lance assembly as claimed in claim 13 wherein a tap hole plugging tool is included, and the said tap hole plugging tool comprises a shaft member that is removably fastenable to the oxygen lance assembly at one end, and the shaft extends in the direction of the metal tubing of the lance and has a plunger permanently attached at the opposite end of the shaft, the said plunger being capable of holding a plug of suitable material for the tap hole, and the oxygen lance assembly with the plugging tool attached is then used to position and force the plug into position relative to the tap hole, thereby enabling the oxygen lance assembly to be reconfigurable to allow it to both open or close furnace tap holes.

15. The oxygen lance assembly as claimed in claims 5 wherein the tail end of the metallic tubing in one reel is connectable to the leading end of the metallic tubing in a subsequent reel so as to allow substantially continuous operation of the said lance as each reel of metallic tubing is consumed during use.

16. The oxygen lance assembly as claimed in claim 15 wherein the connection of the tail end of the metallic tubing in one reel to the leading end of the metallic tubing in a subsequent reel is substantially gas tight.

17. The oxygen lance assembly as claimed in claim 16 wherein the tail end of the said metallic tubing has a region of reduced diameter wherein the outer diameter of the said region is capable of being inserted into the inner diameter of the leading end of a new coil of metallic tubing such that when a said reel of metallic tubing is consumed, the leading end of new reel of metallic tubing is slid over the said region of reduced diameter so as to connect the ends of the metallic tubing together.

18. The oxygen lance assembly as claimed in claim 17 wherein the said reel is capable of accommodating a coil of metallic tubing at least 50 or 100 metres or more in linear uncoiled length, however in consideration of weight and handling requirements, the said coils are typically in the range of 18 to 30 metres in linear uncoiled length.

19. The oxygen lance assembly as claimed in claim 18 wherein the said lance is carried on a body that is suspended from a ceiling, and the body is movable in three dimensions.

20. The oxygen lance assembly as claimed in claim 19 wherein the assembly contains force feedback information means that give the operator information relating to the forward thrust of the lance when in operation.
